(19) United States
(12) Patent Application Publication
(10) Pub. No.: US 2007/0040797 A1
(43) Pub. Date: Feb. 22, 2007

(54) Driving Technique for a liquid crystal display device

(76) Inventors: Ching-Wen Shih, Tainan (TW); Hsin-Cheng Hung, Tainan (TW); Chia-Hang Lee, Tainan (TW)

Correspondence Address: TROP PRUNER & HU, PC, 1616 S. VOSS ROAD, SUITE 750, HOUSTON, TX, 77057-2631, US

(21) Appl. No.: 11/504,408

(22) Filed: Aug. 15, 2006

(30) Foreign Application Priority Data
Aug. 16, 2005 (TW) 94127844
Mar. 1, 2006 (TW) 95106749

(51) Int. Cl. G09G 3/36

(52) U.S. Cl. 345/102

(57) ABSTRACT

A driving method or apparatus for use in a liquid crystal display (LCD) device stores picture data displayed by the LCD device in plural frame times by comparing first picture data for a first frame time with second picture data for a second, previous frame time, and adjusts a gray level difference between a maximum brightness and a minimum brightness displayed by pixels of the LCD device in the first frame time according to a result of the comparing.

### CROSS REFERENCE TO RELATED APPLICATIONS

This claims the benefit under 35 U.S.C. § 119 of Taiwan patent application No. 94127844, filed Aug. 16, 2005, and of Taiwan patent application No. 95106749, filed Mar. 1, 2006.

### BACKGROUND

Due to features offered by liquid crystal display (LCD) devices, they have become increasingly popular among users. Currently, most of the LCD devices are illuminated by a backlight source that is driven by a “hold-type” drive mechanism. With this type of drive mechanism, the brightness of the backlight source of the LCD device is maintained at a fixed value for each picture frame. The brightness of pixels in an LCD device is determined by rotation of the liquid crystal molecules in the liquid crystal panel. When displaying static images, the brightness of the pixels can be held at a fixed value after the pixels have been driven. Picture flickering usually does not occur when using a hold-type drive mechanism for a backlight source to display static images. However, when displaying dynamic pictures with backlight sources driven by a hold-type drive mechanism, a user may perceive blurring of the displayed images.

Alternatively, backlight sources can be driven with an impulse-type drive mechanism to improve performance of LCD devices when displaying dynamic pictures. The impulse-type backlight source is turned on and off periodically, so that the LCD devices can generally achieve the quality of display of cathode ray tube (CRT) display devices when displaying dynamic pictures. In general, the illumination amplitude of this impulse-type backlight source is maintained at a fixed value; in other words, the difference between the maximum brightness and the minimum brightness of pixels in each picture frame is fixed. However, this approach may cause LCD devices to exhibit poor performance (e.g., flickering may occur) when displaying static pictures.

### BRIEF DESCRIPTION OF THE DRAWINGS

FIG. 1 is a flow diagram of a driving method of a backlight source in a liquid crystal display (LCD) device, in accordance with an embodiment.

FIG. 2A illustrates an example picture data displayed by the LCD device in picture frame time M−1.

FIG. 2B illustrates an example picture data displayed by the LCD device in picture frame time M.

FIG. 3 is a graph of a relationship between illumination brightness of the backlight source of the LCD device over time

FIG. 4 is a graph of a relationship between illumination brightness of the backlight source of the LCD device over time.

FIGS. 5A-5K are graphs of relationships between the illumination amplitude of the backlight source and voltage waveforms of an inverter.

FIG. 6 is a block diagram of a backlight module, in accordance with an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

Generally, in accordance with some embodiments, a procedure is implemented in a liquid crystal display (LCD) device to improve performance of the LCD device when displaying static and dynamic picture images. First, the LCD device determines whether a picture to be displayed by the LCD device is dynamic or static. Then, based on the foregoing determination, one of several driving techniques for driving the backlight source is selected; in addition or alternatively, the LCD device can determine whether to insert a blank picture into the picture to be displayed in order to improve the quality of image display by the LCD device. A “blank picture” refers to an image where all the pixels have the same gray level.

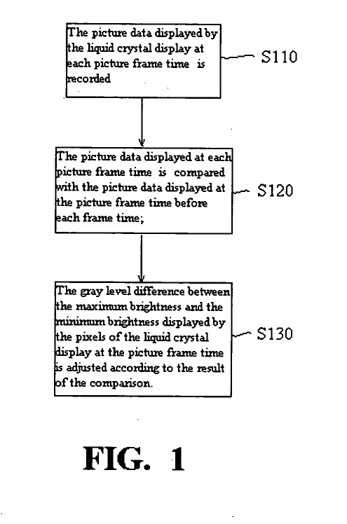

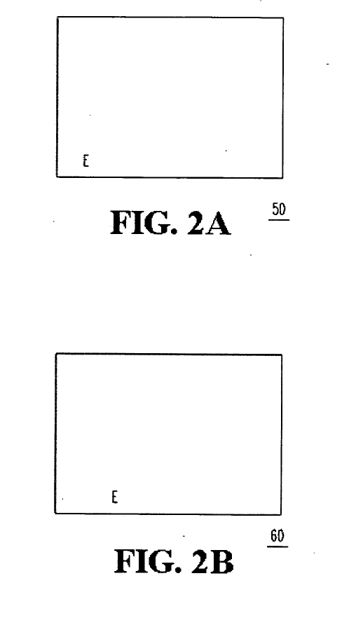

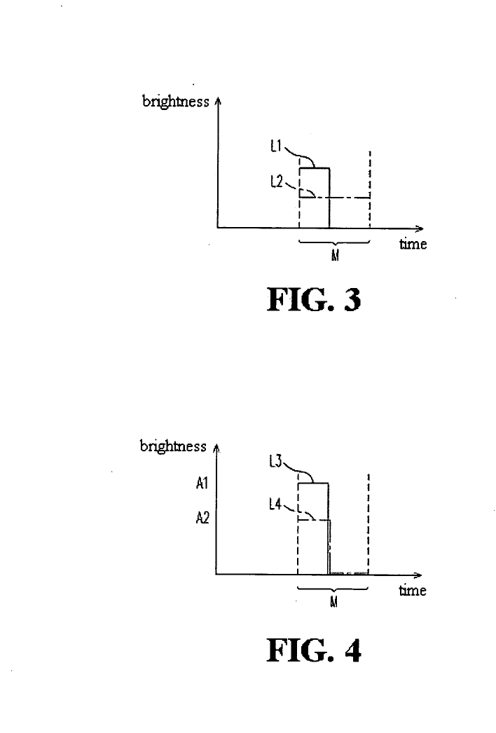

FIG. 1 shows a driving technique for the LCD device, in accordance with an embodiment. FIG. 2A shows picture data displayed by the LCD device in a picture frame at time M−1 (referred to as frame M−1), while FIG. 2B shows picture data displayed by the LCD device in picture frame at time M (referred to as frame M). Time M occurs one frame time after time M−1. In addition, FIG. 3 shows the relationship between the illumination brightness of the backlight source over time. Reference is made to FIGS. 1, 2A, 2B, and 3 in the following discussion.

Initially, the picture data displayed by the LCD device in each picture frame time is recorded (at S110). For example, the picture data 50 (FIG. 2A) displayed in picture frame time M−1, and the picture data 60 (FIG. 2B) in picture frame time M, can be recorded.

Next, the picture data displayed in a particular picture frame time is compared (at S120) with the picture data displayed in the previous picture frame time (the picture frame time before the particular picture frame time). For example, before the picture data 60 in the picture frame time M is displayed by the LCD device, the picture data 50 and picture data 60 are compared to determine whether an identical pattern between the picture data 50 and the picture data 60 exists. Note that the identical pattern can be just a portion (less than the entirety) of each picture data 50, 60.

Next, the gray level difference between the maximum brightness and the minimum brightness displayed by the pixels of the LCD device at the picture frame time is adjusted (at S130) according to the results of the comparison. In some embodiments, adjusting the difference between the maximum brightness and minimum brightness can be performed by adjusting the backlight source, as explained further below.

As an example, if an identical pattern between the picture data 50 and the picture data 60 (such as pattern E) exists, the offset amount of pattern E is calculated. The illumination amplitude of the backlight source of the liquid crystal display at the picture frame time is adjusted according to the offset amount. The illumination amplitude refers to half the difference between the maximum brightness and minimum brightness of the backlight source. As explained further below, the illumination amplitude is controlled by circuitry (e.g., inverter) in a backlight module that also contains the backlight source. Calculating the offset amount is, for example, performed by calculating the distance in pixels between pattern E of the picture data 50 and pattern E of the picture data 60. If the offset amount of pattern E is larger than zero (or larger than some threshold), this means that the picture data 60 relates to a dynamic picture (in other words, picture data 60 is changed from picture data 50 by some amount). When displaying dynamic pictures, the illumination amplitude of the backlight source of the LCD device at the picture frame time M is adjusted according to the offset amount. For example, as depicted in FIG. 3, in frame time M, the illumination amplitude (L1) is adjusted. In FIG. 3, the illumination amplitude (or brightness) L1 is dropped from a first value to a second, lower value. In this way, the LCD device can achieve the impulse-type illumination effect, which is similar to the effect produced by cathode ray tube (CRT) display devices, to eliminate blurring of the picture.

On the other hand, if the offset amount between pattern E of the picture data 50 and pattern E of the picture data 60 is zero (or less than some threshold), or there is no identical pattern between the picture data 50 and the picture data 60, then the picture data 60 is regarded as relating to a static picture. For a static picture, the illumination brightness of the backlight source of the LCD device is not adjusted in frame time M (as indicated by amplitude L2 in FIG. 3). Therefore, there will be no flickering problem when the static picture is displayed by the LCD device, even though an impulse-type backlight source can be used for dynamic pictures.

Alternatively, instead of detecting for a common pattern and then determining an offset between this common pattern in different frame times, the determination of whether the LCD device is displaying a dynamic or a static picture is performed by comparing the gray level difference between the picture data at picture frame time M and the picture data at picture frame time M−1 in the same region (which can be the entire picture or some part less than the entire picture). When the gray level difference between the two pictures in frame times M and M−1 is large (greater than a predefined threshold), the picture data is considered to relate to a dynamic picture, but when the gray level difference between the two pictures in frame times M and M−1 is small (less than the predefined threshold), then the picture data is considered to relate to a static picture. If a dynamic picture is detected, then the illumination amplitude of the backlight source is adjusted. However, if a static picture is detected, then the illumination amplitude is not adjusted.

Alternatively, instead of adjusting the illumination amplitude of a backlight source in response to detecting a dynamic picture, a blank picture can be inserted into the picture data to be displayed by the LCD device. A “blank picture” refers to a picture that has all pixels of the same gray level. A blank picture can be the same size as normal pictures displayed by the LCD device. Alternatively, a blank picture can have a smaller size than a normal picture. A blank picture can be inserted in frame time M and/or in frame time M−1. Insertion of a blank picture that has a low gray level (e.g., a black picture) provides an effect similar to the impulse-type illuminated display for improved performance when displaying dynamic pictures.

FIG. 4 is a chart representing the relationship between the illumination brightness of the backlight source of the LCD device over time, in accordance with another embodiment. In FIG. 3, if the picture data for frame M is related to a static picture, the illumination amplitude is maintained constant, as indicated by L2. However, in FIG. 4, the illumination amplitude is adjusted for both dynamic and static pictures, except that the adjustment for a static picture is by a lesser amount. Generally, the larger the illumination amplitude of the backlight source, the better the quality of a displayed dynamic picture. Thus, in this example, the illumination amplitude of the backlight source is, for example, proportional to the offset amount of pattern E. More specifically, the technique of adjusting the illumination amplitude of the backlight source includes, for example, first determining whether the offset amount of pattern E is larger than a certain threshold value. This threshold value can be set based on specific criteria. For example, the threshold value can be set as a distance expressed as a number of pixels. If the offset amount of pattern E is larger than the threshold value (indicating a dynamic picture), the illumination amplitude of the backlight source at picture frame time M can be set at A1 (as indicated by L3 in FIG. 4). However, if the offset amount of pattern E is smaller than the threshold value (indicating a static picture), the illumination amplitude of the backlight source at picture frame time M is set at A2 (as indicated by L4 in FIG. 4), where A1>A2. Moreover, if the offset amount equals the threshold value, the illumination amplitude of the backlight source at picture frame time M can be somewhere between A1 and A2.

As the illumination amplitude of the backlight source can change with the offset amount of pattern E, the illumination amplitude of the backlight source will be higher when the offset amount of pattern E is set larger than the threshold value, so that blurring of the dynamic picture can be avoided and the quality of the picture can be improved. Moreover, when the offset amount of pattern E is relatively large, the attention of the user will focus on the movement of pattern E and become less sensitive to the blurring of the picture. On the other hand, when the offset amount of pattern E is smaller than the threshold value, the illumination amplitude of the backlight source is set lower. Even though the quality of the dynamic picture is lowered at this time, the blurring is less likely to occur because the offset amount of pattern E is smaller, and the user will less likely notice the blurring of the picture.

In some implementations, the backlight source can include, a number of sub-light sources. In one example, the sub-light sources are cold cathode fluorescent tubes. The technique of adjusting the illumination amplitude of the backlight source can be accomplished by adjusting the amount of current entering the cold cathode fluorescent tubes.

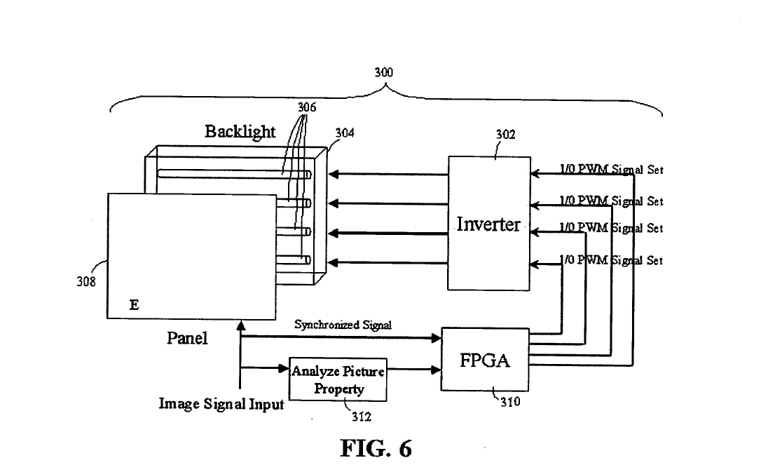

As depicted in FIG. 6, in some embodiments, a backlight module 300 includes a backlight source 304 and an inverter 300. FIG. 6 also depicts an LCD panel 308 that is used with the backlight module 300. The backlight source 304 includes cold cathode fluorescent tubes 306, which produce light emitted through the LCD panel 308 of the LCD device. The backlight module 300 also includes an inverter 302 and a control device 310 (implemented with a field programmable gate array or some other type of integrated circuit device). The inverter 302 can apply voltage waveforms to respective cold cathode fluorescent tubes 308 for adjusting the illumination amplitude of the backlight source 304. The inverter 302 receives pulse width modulation (PWM) signals from the control device 310. The PWM signals can have “1” and “0” states to turn on and off the cold cathode fluorescent tubes 306. The image signal input to the LCD panel 308 is also provided to the control device 310. An analysis circuit 312 is also provided in the backlight module 300 to analyze the image signal input for the purpose of determining whether the displayed picture is a static picture or dynamic picture, as discussed above. As further depicted in FIG. 6, a synchronization signal from the image signal input is also provided to the control device 310 for synchronization purposes.

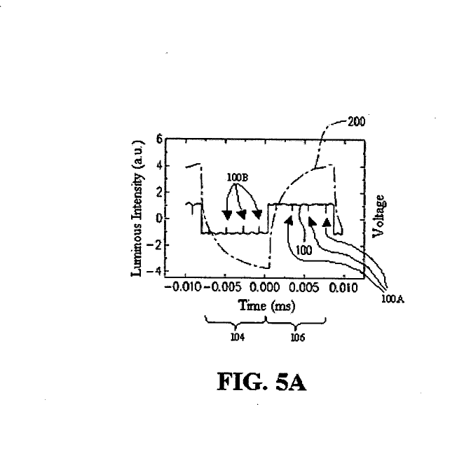

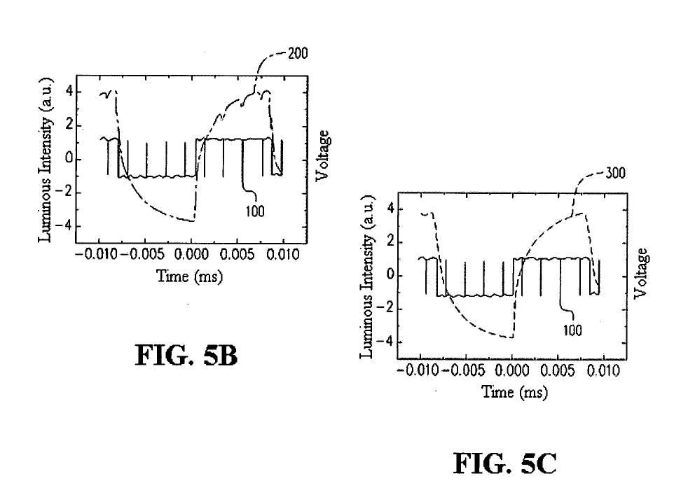

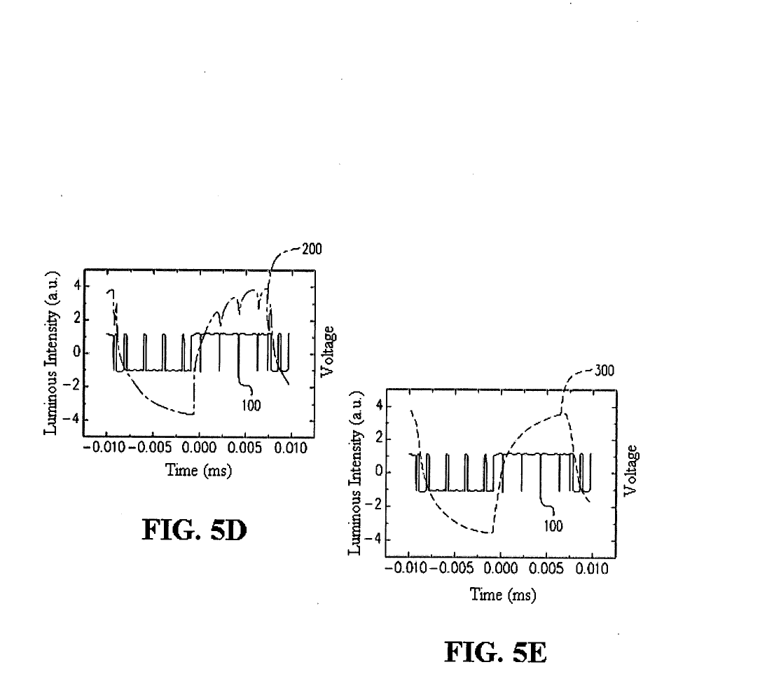

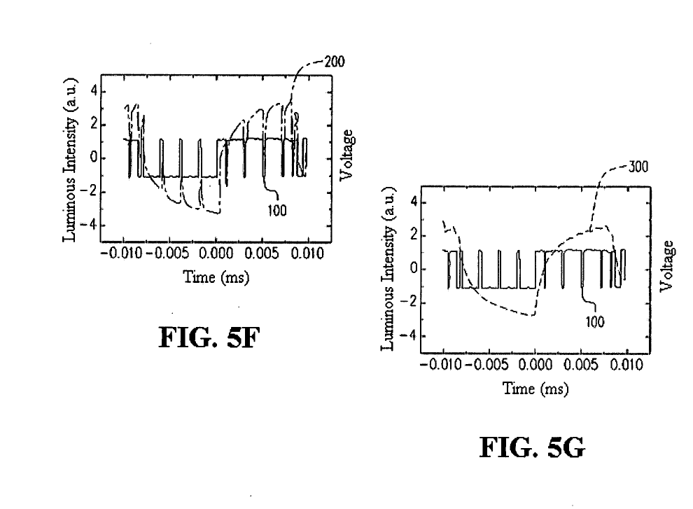

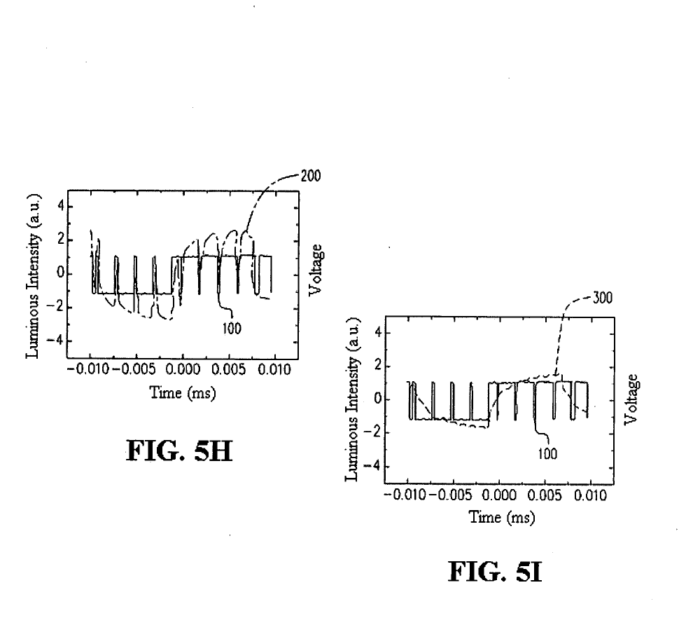

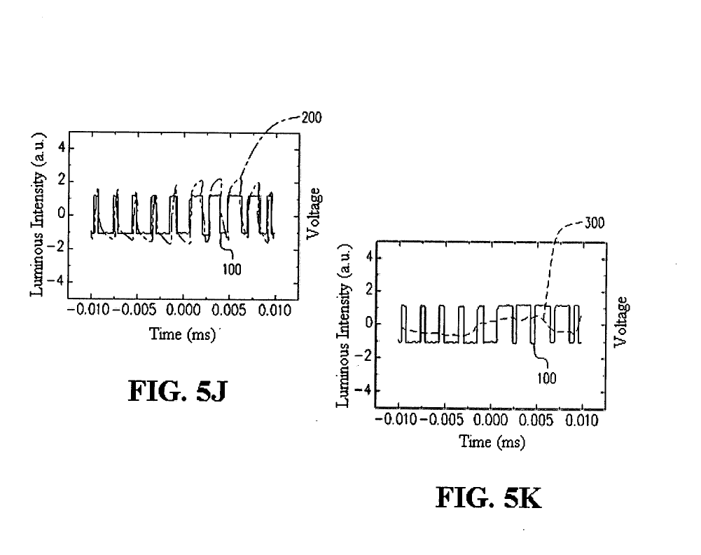

FIGS. 5A-5K illustrate the relationship between the illumination amplitude of the backlight source of the LCD device and the voltage waveforms of the inverters. Referring to FIGS. 5A, 5B, 5D, 5F, and 5H, two curves 100 and 200 are illustrated in each figure. Each curve 100 depicts an output voltage waveform of the inverter 302, and each curve 200 depicts the illumination amplitude of the backlight-source. The illumination amplitude is half the difference between the maximum and minimum of each curve 200. Two curves 100 and 300 are illustrated in each of FIGS. 5C, 5E, 5G, and 5I, where each curve 100 depicts an output voltage waveform of the inverter, and each curve 300 depicts the illumination amplitude perceived by the eyes of a human. As shown in FIGS. 5J-5K, for example, since the eyes of a human act as a low-pass filter, the actual illumination amplitude (curve 200) of the backlight source is different from the illumination amplitude (curve 300) perceived by eyes of a human. The actual illumination amplitude of the backlight source in FIG. 5J is processed through a low-pass filter (the eyes of a human) to form the illumination amplitude perceived by the eyes of a human, as shown in FIG. 5K. By utilizing this characteristic of the human eye and adjusting the output waveform of the inverter 302, the illumination amplitude of the backlight source can be varied such that users will observe different intensities of light. Effectively, the oscillation of the illumination amplitude (200) caused by the oscillation of the output waveform from the inverter 302 is modified by the low-pass filter of human eyes (300). In other words, rather than see the oscillating illumination amplitude of the curve 200 in FIG. 5J, the user perceives the illumination amplitude variation of curve 300 in FIG. 5K.

As depicted in FIGS. 5A-5K, each output voltage waveform of an inverter is separated into a number of positive half-periods and a number of negative half-periods. The voltages of the positive half-periods are larger than zero, and the voltages of the negative half-periods are less than zero. As noted above, adjusting the illumination amplitude of the backlight source includes adjusting the output voltage waveform of the inverter. Referring to FIG. 5A, for example, adjusting the output voltage waveform (100) of the inverter may be accomplished by maintaining the maximum and minimum voltage amplitudes constant; however, a number of falling voltage pulses 100A are generated in positive half-periods 106; and a number of rising voltage pulses 100B are generated in negative half-periods 104. A rising voltage pulse is a pulse with rising voltage, and a falling voltage pulse is a pulse with falling voltage. The falling voltage pulses 100A and rising voltage pulses 100B effectively are used to vary the illumination amplitude. Similar techniques are applied in the waveforms depicted in FIGS. 5B-5K.

In FIGS. 5B-5K, the rising voltage pulses in the negative half-periods go from a negative voltages to positive voltages—these rising voltage pulses are also referred to as positive voltage pulses. Also, falling voltage pulses in the positive half-periods go from positive voltages to negative voltages—these falling voltage pulses are also referred to as negative voltage pulses.

Thus, as shown in FIG. 5A to FIG. 5K, the illumination amplitudes of the backlight source as perceived by eyes of a human are varied after changing the output voltage waveform of the inverter using the falling and rising pulses.

In one implementation, two or more inverters can be disposed in a backlight module for adjusting the illumination amplitude of the backlight source. The illumination amplitude of the backlight source can be varied by driving a number of the inverters to apply the voltages with different maximum and minimum voltage amplitudes to the cold cathode fluorescent tubes. In another implementation, however, since the maximum and minimum voltage amplitudes are maintained constant, only one inverter is needed in the backlight module. This can help reduce the cost of the backlight module.

In an alternative embodiment, if the backlight source includes an array of illuminating diodes, adjusting the illumination amplitude of the backlight source is performed by adjusting the amount of current entering those illuminating diodes, or by adjusting the number of the illuminating diodes in the array.

In another embodiment, if the backlight source is a scan-type light source, a plurality of sub-light sources of the backlight source corresponding respectively to different blocks in the LCD device can be controlled separately (such as by turning on and off the sub-light sources periodically). In this case, in addition to adjusting the illumination amplitude of all sub-light sources as described above, adjusting the illumination amplitude of the backlight source can also be performed by independently adjusting the illumination amplitude of the sub-light sources in the particular block where pattern E is located. Thus, in response to determining that the offset amount of a pattern is larger than the threshold value, the illumination amplitude of the sub-light source of the backlight source corresponding to the block in which the pattern E is located in picture frame time M, is set at A1, however, if the offset amount is smaller than the threshold value, the illumination amplitude of the sub-light source of the backlight source corresponding to the block in which the pattern E is located in picture frame time M is set at A2, where A1>A2. Moreover, when the offset amount equals the threshold value, the illumination amplitude of the sub-light source of the backlight source can be somewhere between A1 and A2.

Similarly, if the sub-light sources are cold cathode fluorescent tubes and the backlight source further includes an inverter, the illumination amplitude of the scan-type backlight source can be varied by adjusting the output voltage waveform of the inverter. The technique of adjusting the illumination amplitude of the scan-type backlight source is similar to above.

As noted above, in another embodiment, the technique of improving the display quality of the LCD device in the picture frame time M can also be performed by inserting a blank picture into the picture data displayed in the picture frame time M; in other words, picture data having a low gray level is inserted during a certain period in picture frame time M to achieve an effect similar to the impulse-type illuminated display. The gray level value of the inserted blank picture is, for example, non-proportional to the offset amount of pattern E. As an example, the technique of inserting a blank picture includes first determining whether the offset amount is larger than the above mentioned threshold value. If the offset amount is larger than the threshold value, a first blank picture is inserted. However, if the offset amount is smaller than the threshold value, a second blank picture is inserted, where the gray level of the second blank picture is higher that the gray level of the first blank picture. Moreover, when the offset amount equals the reference value, the inserted blank picture can be somewhere between the first blank picture and the second blank picture.

As the gray level of the inserted blank picture can change with the offset amount of pattern E, the gray level value of the blank picture can be set lower when the offset amount of pattern E is larger than the threshold value, so the blurring of a dynamic picture can be avoided. Moreover, when the offset amount of the pattern E is relatively large, the attention of the user will focus on the movement of pattern E and become less sensitive to the blurring of the picture.

On the other hand, when the offset amount of pattern E is smaller than the threshold value, the gray level value of the blank picture is set higher. Although the quality of the dynamic picture is lowered at this time, the blurring is less likely to occur because the offset amount of pattern E is insignificant, and the user will less likely notice the blurring of the picture. Moreover, since the insertion of the blank picture is performed with the scanning and distribution of lines of the LCD device, the blank picture can be inserted into the complete picture data, or be inserted only into parts of the picture data which show pattern E.

To compensate for the effect of inserting a blank picture on the picture brightness displayed by the LCD device, the gray level of the picture data displayed in picture frame time M can be increased before the blank picture is inserted. Also in this example, the effect of inserting a blank picture on the picture brightness displayed by the liquid crystal can be compensated by enhancing the illumination strength of the backlight source in picture frame time M.

In sum, the ability to adjust the illumination amplitude of the backlight source or inserting a blank picture enables the selection of an impulse-type drive or a hold-type drive backlight source according to the nature of the picture (dynamic or static) displayed by the LCD device. When the picture data displayed by the LCD device relate to a dynamic picture, the impulse-type driving technique will be selected, and when the picture data displayed by the LCD device relate to a static picture, the hold-type driving technique will be selected. Selection of an impulse-type driving technique is achieved by either changing the illumination amplitude or inserting a blank picture. Selection of a hold-type driving technique is achieved by not changing the illumination amplitude or inserting a blank picture. The gray level difference between the maximum brightness and the minimum brightness displayed by the same pixels at each picture frame time varies with the different offset magnitudes of the pictures; in other words, the larger the picture offset, the larger the gray level difference between the maximum brightness and the minimum brightness displayed by the same pixels at each picture frame time. When the picture is static, the maximum brightness equals the minimum brightness displayed by the same pixels at each picture frame time.

On the other hand, in addition to differentiating dynamic picture from static picture based on picture data, selecting impulse-type or hold-type drive techniques for driving the backlight source also can be based on the complexity or simplicity of the picture data. The so-called complexity or simplicity of the picture data refers to the relationship between the gray level values displayed by each pixel within the same picture data. If the gray level values of the pixels in the picture data are close to each other, this indicates simplicity of the picture data, and the hold-type is selected for driving the backlight source. If the gray level of the pixels in picture data varies significantly (larger than some predefined threshold), this indicates that the picture data is complex, and the impulse-type drive technique is selected for driving the backlight source.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A driving method for use in a liquid crystal display (LCD) device, comprising:
storing picture data displayed by the LCD device in plural frame times;
comparing first picture data for a first frame time with second picture data for a second, previous frame time; and
adjusting a gray level difference between a maximum brightness and a minimum brightness displayed by pixels of the LCD device in the first frame time according to a result of the comparing.

2. The driving method of claim 1, wherein the LCD device has a backlight source, and wherein adjusting the gray level difference between the maximum brightness and the minimum brightness displayed by the pixels includes adjusting an illumination amplitude of the backlight source.

3. The driving method of claim 2, wherein adjusting the illumination amplitude of the backlight source comprises:
determining whether the picture data in the first frame time relates to a dynamic picture or to a static picture; and
if the picture data in the first frame time relates to a dynamic picture, the illumination amplitude of the backlight source at the picture frame time is set at A1, and if the picture data in the first frame time relates to a static picture, the illumination amplitude of the backlight source in the first frame time is set at A2, where A1>A2.

4. The driving method of claim 2, wherein the backlight source includes cold cathode fluorescent tubes, and wherein adjusting the illumination amplitude of the backlight source comprises adjusting current entering the cold cathode fluorescent tubes.

5. The driving method of claim 4, wherein the backlight source further includes an inverter configured to apply voltage waveforms to respective cold cathode fluorescent tubes for adjusting the illumination amplitude of the backlight source, each voltage waveform separated into a number of positive half-periods and a number of negative half-periods, and wherein adjusting the illumination amplitude of the backlight source includes adjusting the voltage waveforms of the inverter.

6. The driving method of claim 5, wherein adjusting the voltage waveforms includes:
maintaining maximum and minimum voltage amplitudes of each voltage waveform constant,
generating a number of negative voltage pulses in the positive half-periods, and generating a number of positive voltage pulses in the negative half-periods.

7. The driving method of claim 5, wherein adjusting the voltage waveforms includes:
maintaining maximum and minimum voltage amplitudes of each voltage waveform constant,
generating a number of falling voltage pulses in the positive half-periods, and
generating a number of rising voltage pulses in the negative half-periods.

8. The driving method of claim 2, wherein the backlight source includes an array of illuminating diodes, and wherein adjusting the illumination amplitude of the backlight source includes one of (1) adjusting current entering the illuminating diodes, and (2) adjusting a number of illuminating diodes in the array of illuminating diodes.

9. The driving method of claim 1, wherein the LCD device has a scan-type backlight source comprising a number of sub-light sources that correspond to different blocks of the LCD device, and wherein adjusting the gray level difference between the maximum brightness and the minimum brightness displayed by the pixels comprises:
determining whether the picture data of each block in the first frame time relate to a dynamic picture or to a static picture; and
if the picture data of a particular block in the first frame time relates to a dynamic picture, the illumination amplitude of the scan-type backlight source corresponding to the sub-light source in the particular block in the first frame time is set at A1, and if the picture data of the particular block in the first frame time relates to a static picture, the illumination amplitude of the scan-type backlight source corresponding to the sub-light source in the particular block in the first frame time is set at A2, where A1>A2.

10. The driving method of claim 1, wherein the LCD device has a scan-type backlight source including a number of sub-light sources that correspond respectively to different blocks of the LCD device, and wherein adjusting the gray level difference between the maximum brightness and the minimum brightness displayed by the pixels in the first frame time comprises:
determining whether the picture data in each block in the first frame time is complex or simple; and
if the picture data in a particular block is complex, the illumination amplitude of the scan-type backlight source corresponding to the sub-light source of the particular block in the first frame time is set at A1, and if the picture data in the particular block is simple, the illumination amplitude of the scan-type backlight source corresponding to the sub-light source in the particular block in the first frame time is set at A2, where A1>A2.

11. The driving method of claim 1, wherein adjusting the gray level difference between the maximum brightness and the minimum brightness displayed by the pixels includes inserting a blank picture.

12. The driving method of claim 11, further comprising adjusting the gray level value of the inserted blank picture to adjust the gray level difference.

13. The driving method of claim 11, wherein inserting the blank picture includes:
determining whether the picture data in the first frame time relates to a dynamic picture or to a static picture; and
if the picture data in the first frame time relates to a dynamic picture, a first blank picture is inserted, and if the picture data in the first frame time relates to a static picture, a second blank picture is inserted, where the gray level value of the second blank picture is higher than the gray level value of the first blank picture.

14. The driving method of claim 11, wherein inserting the blank picture includes:
determining whether the picture data in the first frame time is complex or simple; and
if the picture data in the first frame time is complex, a first blank picture is inserted, and if the picture data in the first frame time is simple, a second blank picture is inserted, where the gray level value of the second blank picture is higher than the gray level value of the first blank picture.

15. The driving method of claim 14, wherein inserting the first blank picture or the second blank picture comprises inserting the first blank picture or the second blank picture into at least a part of the picture data in the first frame time.

16. The driving method of claim 14, further comprising increasing the gray level value of the picture data in the first frame time before inserting the first blank picture or the second blank picture.

17. The driving method of claim 14, wherein the LCD device has a backlight source, the method further comprising increasing an illuminating strength of the backlight source in the first frame time before inserting the first blank picture or the second blank picture.

18. A liquid crystal display (LCD) device, comprising:
a display panel; and
a backlight source to provide light to the display panel; and
a circuit to control the backlight source, the circuit to:
compare picture data in successive frame times, and
adjusting an illumination amplitude of the backlight source for a particular frame time according to the comparing.

19. The LCD device of claim 18, wherein the circuit identifies the picture data in the particular frame time as a dynamic picture data or a static picture data based on the comparing.

20. The LCD device of claim 18, wherein the circuit identifies the picture data in the particular frame time as a complex picture data or a simple picture data based on the comparing.

21. The LCD device of claim 18, wherein the adjusted illumination amplitude of the backlight source causes a difference of brightness between a maximum brightness and a minimum brightness of pixels of the display panel in the particular frame time to be adjusted.

22. The LCD device of claim 18, wherein the circuit adjusts the illumination amplitude in the particular frame time in response to detecting the picture data for the particular frame time relates to a dynamic picture, wherein the detecting is based on the comparing.

23. The LCD device of claim 22, wherein the circuit does not adjust the illumination amplitude in the particular frame time in response to detecting the picture data for the particular frame time relates to a static picture.

24. The LCD device of claim 18, wherein the circuit adjusts the illumination amplitude according to an offset between an identical pattern in the picture data for the particular frame time and in the picture data for a second frame time prior to the particular frame time.

25. The LCD device of claim 24, wherein the circuit sets the illumination amplitude at A1 in response to an offset of a first amount, and sets the illumination amplitude at A2 in response to an offset of a second amount, where A1>A2.

26. A liquid crystal display (LCD) device, comprising:
a display panel; and
a backlight source to provide light to the display panel; and
a circuit to:
analyze picture data for display by the display panel in a particular frame time, and
adjust a gray level difference between a maximum brightness and a minimum brightness displayed by pixels of the LCD device in the particular frame time according to the analyzing.

27. The LCD device of claim 26, wherein the circuit inserts a blank picture in the particular frame time to perform the adjusting.

28. The LCD device of claim 27, wherein the circuit inserts the blank picture having a first gray level in response to detecting the picture data for the particular frame time relates to a dynamic picture, wherein the detecting is based on the analyzing.

29. The LCD device of claim 28, wherein the circuit inserts the blank picture having a second gray level in response to detecting the picture data for the particular frame time relates to a static picture, wherein the second gray level is greater than the first gray level.

30. The LCD device of claim 26, wherein the circuit adjusts an illumination amplitude of the backlight source according to the analyzing.

31. The LCD device claim 26, wherein the circuit analyzes the picture data by determining whether the picture data in the particular frame time is complex or simple.

32. The LCD device of claim 26, wherein the circuit analyzes the picture data by comparing the picture data in successive frame times to determine whether the picture data for the particular frame time is dynamic or static.
